(19) United States
(12) Patent Application Publication
(10) Pub. No.: US 2024/0193629 A1
(43) Pub. Date: Jun. 13, 2024

(54) METHOD AND SYSTEM FOR PREDICTING OPERATIONAL INDICATORS WHERE A DEMAND MODEL IS TRAINED AND UPDATED

(71) Applicant: DUN-QIAN Intelligent Technology Co., Ltd., Taichung City (TW)

(72) Inventors: Yen-Chu Chen, Chiayi City (TW); Ling-Jung Lin, Tainan City (TW); Shao-Chen Liu, Taichung City (TW); Hsuan-Wei Chen, Taichung City (TW); Shuh-Shian Tsai, New Taipei City (TW)

(73) Assignee: DUN-QIAN Intelligent Technology Co., Ltd., Taichung City (TW)

(21) Appl. No.: 18/089,548

(22) Filed: Dec. 27, 2022

(30) Foreign Application Priority Data
Dec. 9, 2022 (TW) 111147365

(51) Int. Cl. G06Q 30/0202

(52) U.S. Cl. CPC G06Q 30/0202

(57) ABSTRACT

A method for predicting operational indicators includes performing a training operation according to first data to train a demand model, inputting second data into the demand model to generate predicted demand data, collecting actual demand data, and performing an adjustment operation according to the predicted demand data and the actual demand data to update the demand model.

### BACKGROUND OF THE INVENTION

### 1. Field of the Invention

The disclosure is related to a method and a system for predicting operating indicators, and more particularly, a method and a system for predicting operating indicators where a demand model is trained and updated.

### 2. Description of the Prior Art

In marketing, if operating indicators (e.g. sales amount and turnover) can be estimated, marketing strategies can be planned ahead of time. For example, when managing a hotel, the predicted sales amount in next two weeks or 30 days can be used for making marketing strategies and managing personnel and hotel facilities.

However, predicting the operating indicators can be a challenging task because the operating indicators are affected by many factors. At present, predictions are made according to personal instinct and the sales records of comparable periods in the past. In this way, the accuracy of predictions and factors taken into account are highly limited. Hence, a proper solution is still in need for predicting operating indicators.

### SUMMARY OF THE INVENTION

An embodiment provides a method for predicting operational indicators. The method includes performing a training operation according to first data to train a demand model, inputting second data into the demand model to generate predicted demand data, collecting actual demand data, and performing an adjustment operation according to the predicted demand data and the actual demand data to update the demand model.

Another embodiment provides a system used to predict operational indicators. The system includes a first data unit, a second data unit, a demand model and a training unit. The first data unit is used to provide first data. The second data unit is used to provide second data. The demand model is used to generate predicted demand data according to the second data. The training unit is used to train the demand model according to the first data, and perform an adjustment operation according to the predicted demand data and actual demand data to update the demand model.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a system for predicting operational indicators according to an embodiment.

FIG. 2 is a flowchart of a method for predicting operational indicators according to an embodiment.

FIG. 3 is a flowchart of an adjustment operation performed according to predicted demand data and actual demand data for updating the demand model.

### DETAILED DESCRIPTION

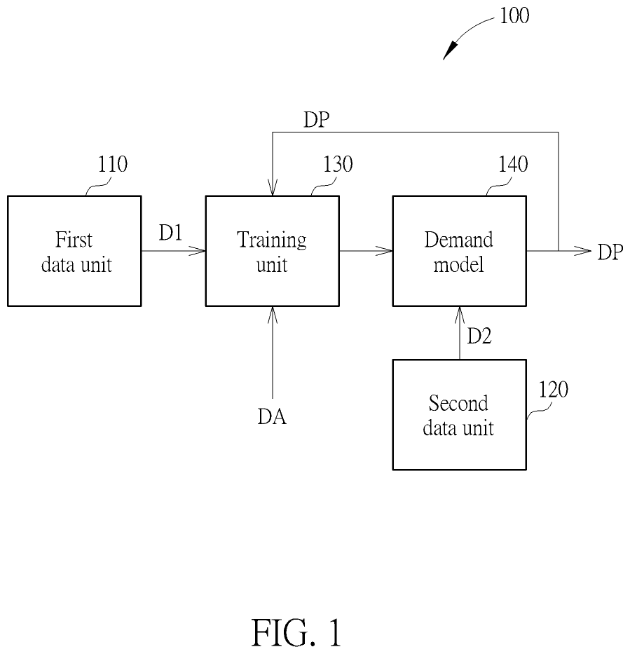

FIG. 1 illustrates a system 100 for predicting operational indicators according to an embodiment. The system 100 can include a first data unit 110, a second data unit 120, a training unit 130 and a demand model 140.

The first data unit 110 can provide first data D1. The first data D1 can be historical data (e.g. historical data of the past year). The second data unit 120 can provide second data D2, and the second data D2 can be real-time data to be evaluated.

The demand model 140 can generate predicted demand data DP according to the second data D2. For example, the predicted demand data DP can include daily sales amount of several days in the future. In other words, the predicted demand data DP can include the predicted operating indicators.

The training unit 130 can train the demand model 140 according to the first data D1, and perform an adjustment operation according to the predicted demand data DP and actual demand data DA to update the demand model 140. For example, when the system 100 starts to operate, the first data D1 can be inputted to the training unit 130 to generate and train the demand model 140. After the demand model 140 generates the predicted demand data DP (e.g. the predicted sales amount), the actual demand data DA (e.g. the actual sales amount) can be generated according to actual operating records. The predicted demand data DP and the actual demand data DA can be inputted to the training unit 130 for the training unit 130 to adjust and improve the demand model 140. More details are described below.

Each of the first data unit 110 and the second data unit 120 can include or be implemented in a memory device such as a non-volatile memory device. Each of the first data unit 110 and the second data unit 120 can include or be disposed in a local hardware device or a remote hardware device (e.g. cloud device). The first data unit 110 and the second data unit 120 can be implemented in two separate hardware devices or integrated in the same hardware device.

Each of the training unit 130 and the demand model 140 can be implemented using hardware device(s), such as a central processing unit (CPU), a controller, a tensor processing unit (TPU), a graphic processing unit (GPU), an accelerated processing unit (APU) and/or another hardware device with computation ability. The training unit 130 and the demand model 140 can be implemented in two separate hardware devices or integrated in the same hardware device. The training unit 130 can include software and/or hardware. The demand model 140 can include software and/or hardware.

Each path among the first data unit 110, the second data unit 120, the training unit 130 and the demand model 140 in FIG. 1 can include a path of physical wire, a wireless path and/or a virtual path. For example, a cable, a transmission line, a semiconductor trace, a wire of a circuit board, a Wi-Fi path, a 5G communication path, a 6G communication path and/or a Bluetooth path can be used, and embodiments are not limited thereto.

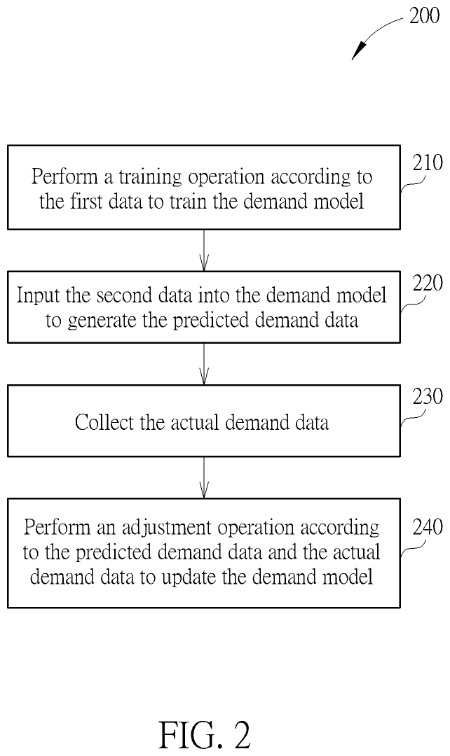

FIG. 2 illustrates a method 200 for predicting operational indicators according to an embodiment. As shown in FIG. 1 and FIG. 2, the method 200 can include the following steps.
Step 210: perform a training operation according to the first data D1 to train the demand model 140;
Step 220: input the second data D2 into the demand model 140 to generate the predicted demand data DP;
Step 230: collect the actual demand data DA; and
Step 240: perform an adjustment operation according to the predicted demand data DP and the actual demand data DA to update the demand model 140.

The first data unit 110 and the training unit 130 can be used to perform Step 210. The second data unit 120 and the demand model 140 can be used to perform Step 220. The training unit 130 can be used to perform Step 240.

The demand model 140 can include a long short term memory (LSTM) model. For example, the demand model 140 can include a three-layer stacked long short term memory model. When the training unit 130 is in use to train the demand model 140, the training operation can include a logistic regression operation; however, embodiments are not limited thereto. Other proper neural networks and training operations can also be used.

The first data D1 can include the first historical data to the nth historical data, and n is an integer larger than zero. The second data D2 can include the first real-time data to the nth real-time data, where the ith historical data and the ith real-time data have the same format, i is an integer, and 0<i≤n.

In other words, the data type, the data format and the number of data of the first data D1 have to be the same as that of the second data D2, so that the demand model 140 can be used to perform weighting calculations.

For example, if the system 100 and the method 200 are used to predict the sales of hotel room, the first data D1 can include historical online travel agency (OTA) rates, historical weather data, historical press releases, historical economic data and/or historical sales data. The historical online travel agency rates can be collected using web crawlers or by searching on the internet. The historical online travel agency rates can be room rates of the competitors. The historical weather data, the historical press releases and the historical economic data can be used to evaluate the relationships among weather, press releases, economic indicators and sales amount. The historical sales data can be collected through a property management system (PMS). Corresponding to the first data D1, the second data D2 can include current online travel agency rates, current weather data, current press releases, current economic data and/or current sales data.

In the abovementioned historical sales data and current sales data, “room night” can be the unit of the sales of hotel rooms. When N rooms are booked for M days, the number of room nights can be the product of N and M (i.e. N×M). For example, when one room is booked for one day, the number of room nights can be 1. When one room is booked for two days, the number of room nights can be 2. When two rooms are booked for one day, the number of room nights can also be 2.

In FIG. 1 and FIG. 2, the predicted demand data DP generated by the demand model 140 can include x predicted sales amounts of x days, where x is an integer larger than zero. For example, if x is 30, and the system 100 is used for predicting operating indicators of managing a hotel, the predicted demand data DP can include daily sales amount of next 30 days, that is 30 numbers of room nights.

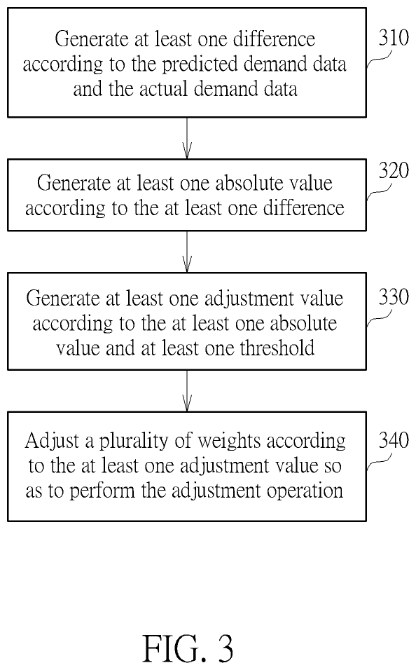

FIG. 3 illustrates the adjustment operation performed according to the predicted demand data DP and the actual demand data DA for updating the demand model 140. The flow in FIG. 3 can be corresponding to Step 240 in FIG. 2 and include following steps.
Step 310: generate at least one difference according to the predicted demand data DP and the actual demand data DA;
Step 320: generate at least one absolute value according to the at least one difference;
Step 330: generate at least one adjustment value according to the at least one absolute value and at least one threshold; and
Step 340: adjust a plurality of weights according to the at least one adjustment value so as to perform the adjustment operation.

In Step 330, the at least one adjustment value can include a bonus point and/or a penalty point. Below, an example is described to explain the flow in FIG. 3. In Step 310, if the predicted demand data DP includes daily sales amount of the next 30 days, the predicted demand data DP can include 30 values (expressed as P1 to P30). After collecting data for 30 days, the actual demand data DA can also include 30 values (expressed as A1 to A30) corresponding actual sales amounts. After subtraction is performed, at least one differences, such as (P1-A1), (P2-A2) . . . (P30-A30), can be obtained.

In Step 320, at least one absolute value (e.g. |P1−A1|, |P2−A2| . . . |P30−A30|) can be generated accordingly. In Step 330, at least one threshold can be used to compare with the at least one absolute value (e.g. |P1−A1|, |P2−A2| . . . |P30−A30|).

If the absolute values are larger than the threshold, it means the predicted demand data DP deviates greater from the actual demand data DA, so the at least one adjustment value in Step 330 can be related to a penalty point (e.g. a negative point). If the absolute values are smaller than the threshold, it means the predicted demand data DP deviates less from the actual demand data DA, so the at least one adjustment value in Step 330 can be related to a bonus point (e.g. a positive point). In another embodiment, a plurality of absolute values in Step 320 can be summed up, and the sum can be compared with a threshold to determine whether the adjustment value corresponds to a bonus point or a penalty point.

In Step 340, the unadjusted weights can be corresponding to the demand model 140 that is not updated yet. In Step 340, if the adjustment value(s) in Step 330 corresponding to a bonus point, the weights in the demand model 140 can be maintained. If the adjustment value(s) in Step 330 corresponding to a penalty point, the weights in the demand model 140 can be adjusted.

If the predicted demand data DP becomes closer to the actual demand data DA when a specific weight of the demand model 140 is increased, the specific weight can be further increased in the demand model 140. If the predicted demand data DP becomes closer to the actual demand data DA when a specific weight of the demand model 140 is decreased, the specific weight can be further decreased in the demand model 140.

If the differences between the predicted demand data DP and the actual demand data DA become greater when a specific weight of the demand model 140 is increased, the specific weight can be decreased. If the differences between the predicted demand data DP and the actual demand data DA become smaller when a specific weight of the demand model 140 is decreased, the specific weight can be increased.

In addition to historical sales records, the system 100 and the method 200 can also take other environmental factors into account. Hence, the effects caused by environmental factors can be evaluated. According to embodiments, instead of classification model, a time series prediction model (with target variables) can be used to directly predict the product demand for a period of time in the future. Architectures of time series algorithm such as long short term memory (LSTM) and logistic regression can be used to predict the sales amount of “a period of time” as much as possible. A prediction model (e.g. the demand model 140) can be built to evaluate operating indicators such as room reservation demand and sales amounts in the future. A mechanism of penalty and bonus can be realized by comparing the predicted demand and the actual demand to continuously and dynamically update the prediction model. Hence, the accuracy of the forecast of operational indicators is improved. The purpose of the system 100 and the method 200 is to predict the product demand as close to the actual demand as possible in advance. In addition to the historical sales data, the room rates of competitors, uncontrollable environmental factors (e.g. weather), and factors related to the whole market (e.g. economic indicators and press releases) can be also taken into account.

In summary, the system 100 and the method 200 can be used to provide a solution to predict operating indicators according to a plurality of factors. It is helpful for marketing and managing time-sensitive perishable products such as hotel rooms, air tickets and performance tickets. For marketing hotel rooms, the system 100 and the method 200 are especially useful.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for predicting operational indicators, comprising:
performing a training operation according to first data to train a demand model;
inputting second data into the demand model to generate predicted demand data;
collecting actual demand data; and
performing an adjustment operation according to the predicted demand data and the actual demand data to update the demand model.

2. The method of claim 1, wherein the first data comprises first historical data to nth historical data, and n is an integer larger than zero.

3. The method of claim 2, wherein the second data comprises first real-time data to nth real-time data, ith historical data and ith real-time data have a same format, i is an integer, and 0<i≤n.

4. The method of claim 1, wherein the first data comprises historical online travel agency rates, historical weather data, historical press releases, historical economic data and/or historical sales data.

5. The method of claim 1, wherein the second data comprises current online travel agency rates, current weather data, current press releases, current economic data and/or current sales data.

6. The method of claim 1, wherein the demand model comprises a long short term memory (LSTM) model.

7. The method of claim 1, wherein the training operation comprises a logistic regression operation.

8. The method of claim 1, wherein the predicted demand data comprises x predicted sales amounts corresponding to x days, and x is an integer larger than zero.

9. The method of claim 1, wherein performing the adjustment operation according to the predicted demand data and the actual demand data, comprises:
generating at least one difference according to the predicted demand data and the actual demand data;
generating at least one absolute value according to the at least one difference;
generating at least one adjustment value according to the at least one absolute value and at least one threshold; and
adjusting a plurality of weights according to the at least one adjustment value so as to perform the adjustment operation;
wherein the at least one adjustment value comprises a bonus point and/or a penalty point.

10. A system configured to predict operational indicators, comprising:
a first data unit configured to provide first data;
a second data unit configured to provide second data;
a demand model configured to generate predicted demand data according to the second data; and
a training unit configured to train the demand model according to the first data, and perform an adjustment operation according to the predicted demand data and actual demand data to update the demand model.
